(19) United States
(12) Patent Application Publication
(10) Pub. No.: US 2010/0141008 A1
(43) Pub. Date: Jun. 10, 2010

(54) HEADREST FOR THE SEAT OF AN AUTOMOTIVE VEHICLE AND AUTOMOTIVE VEHICLE SEAT PROVIDED WITH SUCH HEADREST

(75) Inventors: Philippe Augade, Chevreuse (FR); Benoit Lambert, Carrieres S/Seine (FR); Olivier Pinon, Montrouge (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Renault S.A.S., Boulogne Billancourt (FR)

(21) Appl. No.: 12/518,671

(22) PCT Filed: Nov. 28, 2007
(86) PCT No.: PCT/FR2007/052411

§ 371 Date: Dec. 29, 2009

(30) Foreign Application Priority Data
Dec. 11, 2006 (FR) 0610767

(51) Int. Cl. B60N 2/48

(52) U.S. Cl. 297/408

(57) ABSTRACT

A headrest that can be mounted on the back of an automotive vehicle seat and including a holding member including a central holding portion and first and second resting portions rotatingly mounted on either side of the central holding portion so as to rotate respectively about first and second rotation axes. The first and second rotation axes of the resting portions essentially cross each other at a point located under the holding member and essentially corresponding to the articulation point of a neck of a user whose head rests against the contact surface of the headrest.

The present invention relates to a headrest for a motor vehicle seat and a seat comprising such a headrest.

Document US 2006/0131947 describes a headrest for a motor vehicle which comprises at least one rod which is capable of interacting with the back of a motor vehicle seat for the attachment of the headrest, a holding element, secured to one end of this rod, which comprises a central holding portion, capable of coming into contact with the back of the head of a user, and two supporting portions lateral to this central holding portion, which are mounted so as to pivot on two axes, parallel to the rod and which are placed in the plane of the holding element. The value of this headrest is that the lateral supporting portions, when they are brought closer to the holding portion, by pivoting, form resting surfaces on which the user can rest the side of his head in order to take a rest. Furthermore, when the supporting portions are brought closer, they also form a lateral support which protects the neck of the user in the event of an accident.

The object of the present invention is to propose a headrest of the aforementioned type which provides enhanced comfort and support.

The object is achieved by means of a headrest capable of being mounted so as to slide on a motor vehicle seat back and comprising a holding element which comprises a central holding portion comprising a contact face designed to be used as a resting surface at the back of the head of a user, and first and second supporting portions, mounted so as to rotate on either side of said central holding portion about, respectively first and second axes of rotation placed substantially in the plane of said contact face, said first and second axes of rotation of said supporting portions substantially intersect at a point which is situated beneath said holding element, and which corresponds substantially to the point of articulation of the neck of a user of whom the back of the head is placed against said contact face.

This particular position of the point of intersection of the axes of rotation makes it possible to provide a good hold of the head and neck of a user.

The distance between the bottom edge of the central holding portion and the point of intersection of the first and second axes of rotation is advantageously between 40 and 70 mm, which makes it possible to obtain the aforementioned configuration.

The first and second axes form, for example, between them an angle of between 30° and 50°.

According to one particular embodiment, the supporting portions are each connected to the central holding portion at an edge which comprises a first segment parallel to the first or to the second axis of rotation and a second segment which extends the first segment and which is substantially perpendicular to the transversal of the contact surface. This arrangement allows an easy articulation of the supporting portions.

The headrest comprises a foam element which covers the central holding portion and the supporting portions in order to form a continuous surface and provide a continuous support to the neck of a user.

Advantageously, the headrest comprises a nape-rest cushion placed on the bottom portion of the central holding portion.

This cushion extends over a height of between 60 and 80 mm from the bottom edge of the headrest.

According to one particular embodiment, the holding element is mounted so as to rotate about a third axis of rotation that is transversal relative to said headrest and placed substantially in the plane of said contact face. This additional rotary movement makes it possible to adapt the headrest of the invention for a child and for more varied positions of an adult user, in particular, for a reclined position of the latter.

The headrest may comprise at least one mounting rod, of which a first end is connected to the bottom portion of the central holding portion and a second end is capable of interacting with the back of a motor vehicle seat.

When the holding element is mounted so as to rotate about a third axis of rotation, the holding element can be moved between an upright position, substantially parallel to the rod, and an inclined position in which the bottom portion of the holding element is furthest away from the rod.

According to one particular embodiment, the rod is mounted so as to slide in the headrest and the headrest comprises means for attachment and for adjusting the length of the rod.

The present invention also relates to a motor vehicle seat comprising a back and a squab. According to the invention, the free edge of the back which is not connected to the squab comprises a headrest according to the invention.

Advantageously, the distance of the headrest relative to the free edge of the back being adjustable, the back comprises a front face designed to come into contact with the back of a user and the holding element is mounted so as to pivot about an axis of rotation that is substantially transversal to the headrest and placed so that the headrest is capable of being brought into a position in which the holding element covers a portion of the front face of the back. This position makes it possible to adapt the headrest of the invention for a child.

The present invention also relates to a motor vehicle seat comprising a back and a squab. According to the invention, the free edge of said back which is not connected to the squab comprises a headrest according to the present invention.

According to one particular embodiment, the distance of the headrest relative to the free edge of the back being adjustable, the back comprising a front face designed to come into contact with the back of a user, the headrest may be brought into a position in which it covers a portion of said front face of the back, which allows it to be adapted to a small-sized user such as a child.

The present invention, its features and the various advantages that it provides will be better understood on reading the following description of two embodiments, presented as nonlimiting examples, and which makes reference to the appended drawings in which:

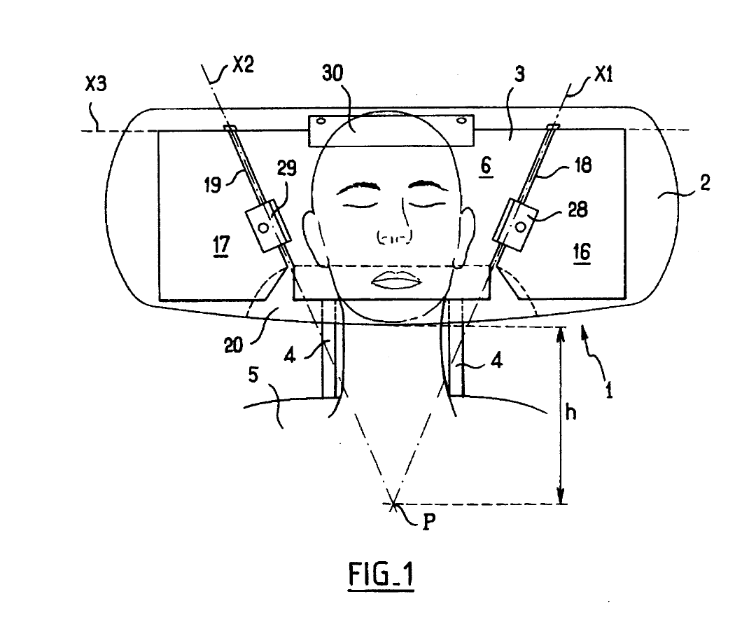

FIG. 1 represents a view in longitudinal section of a first embodiment of the invention;

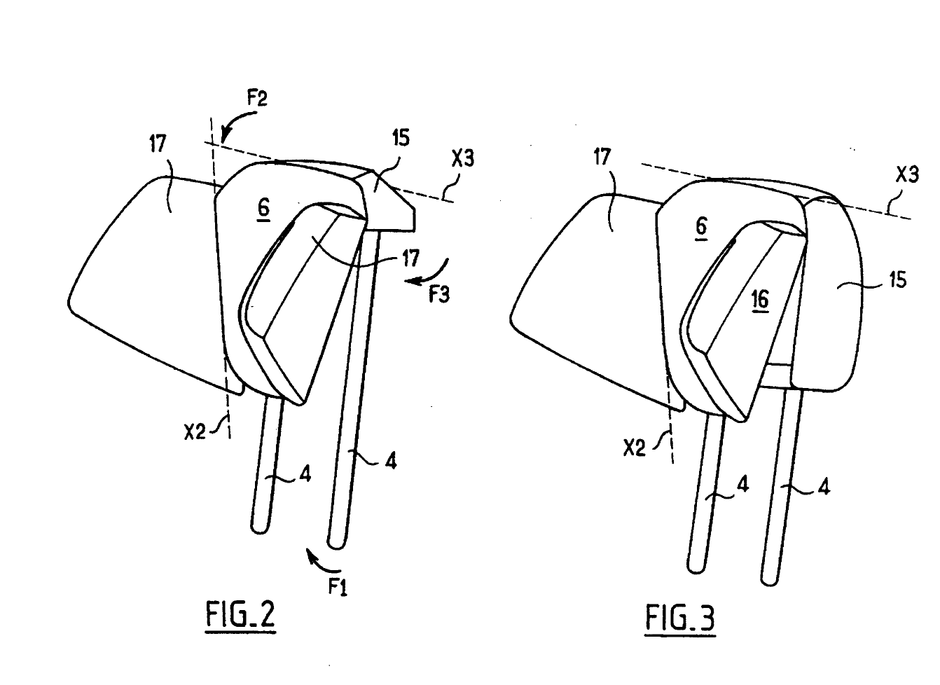

FIG. 2 represents a view in perspective of the first embodiment;

FIG. 3 represents a view in perspective of a second embodiment of the invention;

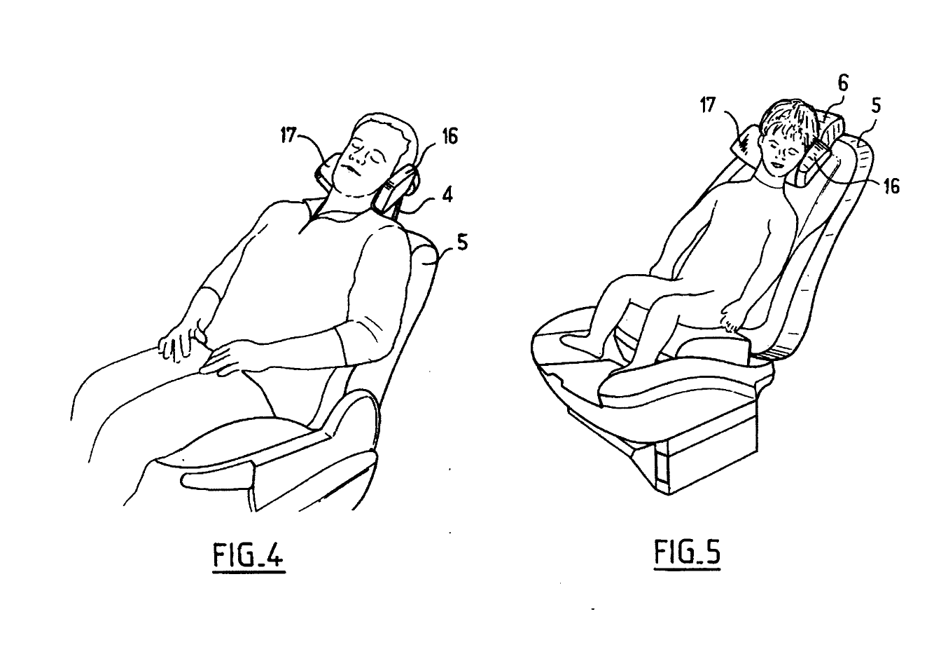

FIG. 4 represents a view in perspective of a seat fitted with a headrest corresponding to the first embodiment of the invention, an adult user being seated on the seat; and

FIG. 5 represents a view in perspective of a seat fitted with a headrest corresponding to the first embodiment of the invention, a child user being seated on the seat.

With reference to FIG. 1, according to a first embodiment of the invention, the headrest comprises a holding element 1 formed by a foam cushion 2 which covers a frame 3. The holding element 1 is supported by two rods 4 which are parallel, and of which a first end is secured to the frame 3 while the second end is mounted on a motor vehicle seat back 5. The frame 3 comprises a central part, which forms the central holding portion 6, and two lateral portions, which form the supporting portions 16 and 17. The supporting portions 16 and 17 comprise an outer edge and an inner edge 18 and 19, respectively, by which they are connected and articulated to the central holding portion 6. This inner edge is formed by a first line segment which extends from the top edge of the frame 3, opposite to the rods 4, to a zone situated close to the bottom edge of the frame 3, which is secured to the rods 4, and by a second line segment which forms, in the particular embodiment shown here, an obtuse angle with the first line segment and connects the latter to the bottom edge of the frame 3. This second segment may also be substantially perpendicular to the transversal of the headrest. The first two line segments of the inner edges 18 and 19 form an acute angle of 44°, in the present case. The two axes X1 and X2 which pass through the first two line segments of the inner edges 18 and 19 intersect at a point P situated beyond the holding portion 6 of the headrest, in the direction of the rods 4 and of the back 5, and which corresponds to the point of articulation of the neck of a user the silhouette of whom is shown in FIG. 1. The height h which separates the lowest point of the cushion 2 from the aforementioned point P is between 40 and 70 mm and, for example, in the order of 60 mm in the present case.

In FIG. 1, the two supporting portions 16 and 17 form a substantially flat surface with the central holding portion 6. The edge of the frame of the holding portion 6 comprises, on each side, a first line segment which is parallel and placed opposite the first line segment of each of the inner edges 18 and 19 of the lateral portions 16 and 17, and a line segment parallel to the rods 4 (i.e. substantially perpendicular to the transversal of the headrest), which connects the first segment to the bottom edge of the holding portion 6. There is therefore a space with no frame situated between the second segment of the edge of the frame of the holding portion 6 and the second segment of the inner edge of each of the lateral supporting portions 16 and 17. This gap makes it possible to articulate the two supporting portions 16 and 17 without the foam of the cushion 2 being an obstacle. The headrest also comprises, in the zone situated between the second segments of the edges of the holding portion 6, a cushion or an extra thickness of foam 20 which serves as a nape-supporting zone and which extends to the supporting portions in order to fill the gaps that exist between the frames of the central holding portion 6 and that of the supporting portions 16 and 17. This cushion 20 protrudes below the frame of the headrest, toward the rods 4, and extends over a height of the order of 75 mm, in the present case. The two supporting portions 16 and 17 are articulated by means of articulations 28 and 29 placed on the first line segments of the inner edges 18 and 19 of the supporting portions 16 and 17. These articulations 28 and 29 make it possible to pivot the supporting portions 16 and 17 about the aforementioned axes X1 and X2. The supporting portions 16 and 17 may therefore pivot toward the head of the user. In the embodiment represented here, these articulations make it possible to position the two supporting portions 16 and 17, by hand, by directly moving these two portions. The latter remain in place because of the friction forces existing in the articulation.

An articulation of another type may also be used without departing from the context of the present invention. An articulation 30, of the same type as mentioned above, is also placed on the top edge of the central portion of the frame 3, so as to allow the articulation of the central holding portion 6 relative to the axis X3, which is parallel to the top and bottom edges of the holding portion 6 and substantially perpendicular to the rods 4.

As shown in FIG. 2, the two supporting portions 16 and 17 may be brought closer to the contact face, that is to say the face which comes into contact with the back of the head of a user, of the central holding portion 6, in a rotary movement, represented by the arrows F1 and F2, about the two aforementioned axes X1 and X2. In this first embodiment, the holding portion 6 may also pivot forward, that is to say in the direction of the contact face, in a movement represented by the arrow F3, about the axis X3. In this embodiment, the headrest includes a backing portion 15, secured to the end of the rods 4, which is opposite to the end of the rods 4 capable of interacting with the back of a vehicle seat. This backing portion 15 comprises a longitudinal edge which supports the articulation 30 which allows the holding portion 6 to pivot about the axis X3. In the configuration shown in FIG. 2, the holding portion 6 and the supporting portions 16 and 17 are pivoted toward the contact face, that is to say that they are moved away from the rods 4, the nape-support zone being the furthest from the rods 4 while the top portion of the holding portion 6 remains connected to the backing portion 15 at the articulation 30. This first embodiment may advantageously be used for fitting to a rear seat of a motor vehicle.

FIG. 3 represents a second embodiment of the invention of which the portions and elements in common with the first embodiment have identical reference numbers. This second embodiment may be used for fitting to a front seat of a motor vehicle. In this second embodiment, the backing portion 15 also extends on a plane parallel to the rods 4 and comprises means for adjusting the length of the protruding rods 4 (not shown). These adjustment means make it possible to adjust the height of the headrest relative to the back of the seat, by sliding the rods 4 in the backing element 15. In FIG. 2, the supporting portions 16 and are in their pivoted position and the holding portion 6 is in its inclined position.

In FIG. 4, the length of the rods 4, that can be seen between the back 5 and the holding portion 6, may be adjusted thanks to adjustment means which are incorporated into the back 5 of the seat. It is therefore possible to adjust the height of the headrest so that the point P (see FIG. 1) is positioned in a zone corresponding substantially to the point of articulation of the neck of an adult user. The individual variations of the position of this articulation are sufficiently small for it to be possible to determine an average position that is valid for any adult individual. The pivoted position of the supporting portions 16 and 17 provides a lateral support that is pleasant and safe. The articulation on the axis X3 makes it possible to increase the comfort of the user in the resting position. In this position, when the holding element is tilted toward the user, it makes it possible to comfortably support the nape of the latter, in a position that is slightly inclined toward the rear of the seat thereby providing a comfortable resting position, when the back 5 of the seat is inclined rearward.

As shown in FIG. 5, the pivoting of the holding element and the adjustment of the height of the headrest relative to the seat-back 5 make it possible to bring the holding portion 6 to the back 5. The central holding portion 6 is therefore superposed on a portion of the back 5 which allows a child user to use the headrest of the invention. The backing portion 15 is shaped and placed so as to allow the holding portion 6 to be superposed on the back 5. In this case, the pivoted position of the supporting portions 16 and 17 makes it possible to ensure an increased lateral hold of the head of the child in the event of an impact. Moreover, the pivoting of the holding portion 6 about the axis X3 also makes it possible to perfectly adapt the position of the holding portion 6 to the morphology of the child.

1-13. (canceled)

14. A headrest configured to be mounted on a motor vehicle seat back, the headrest comprising:
a holding element that comprises a central holding portion comprising a contact face configured to be used as a resting surface at the back of the head of a user, and first and second supporting portions, mounted so as to rotate on either side of the central holding portion about, respectively, first and second axes of rotation placed substantially in the plane of the contact face,
wherein the first and second axes of rotation of the supporting portions substantially intersect at a point situated beneath the holding element, and which corresponds substantially to the point of articulation of the neck of a user of whom the back of the head is placed against the contact face.

15. The headrest as claimed in claim 14, wherein the distance between the bottom edge of the central holding portion and the point of intersection of the first and second axes of rotation is between 40 and 70 mm.

16. The headrest as claimed in claim 14 wherein the first and second axes form between them an angle of between 30° and 50°.

17. The headrest as claimed in claim 14, wherein the supporting portions are each connected to the central holding portion at an edge that comprises a first segment parallel to the first or to the second axis of rotation and a second segment that extends the first segment and that is substantially perpendicular to the transversal of the contact surface.

18. The headrest as claimed in claim 14, further comprising a foam element that covers the central holding portion and the supporting portions to form a continuous surface and to provide a continuous support to the neck of a user.

19. The headrest as claimed in claim 14, further comprising a nape-rest cushion placed on the bottom portion of the central holding portion and of the supporting portions.

20. The headrest as claimed in claim 14, wherein the cushion extends over a height of between 60 and 80 mm from the bottom edge of the headrest.

21. The headrest as claimed claim 14, wherein the holding element is mounted so as to rotate about a third axis of rotation that is transversal relative to the headrest and placed substantially in the plane of the contact face.

22. The headrest as claimed in claim 14, further comprising at least one mounting rod including a first end connected to the bottom portion of the central holding portion and a second end configured to interact with the back of a motor vehicle seat.

23. The headrest as claimed in claim 21, wherein the holding element is mounted so as to rotate about the third axis of rotation, the holding element can be moved between an upright position, substantially parallel to the rod, and an inclined position in which the bottom portion of the holding element is furthest away from the rod.

24. The headrest as claimed in claim 23, wherein the rod is mounted so as to slide in the headrest, and further comprising means for attachment and for adjusting the length of the rod.

25. A motor vehicle seat comprising:
a back and a squab, wherein a free edge of the back that is not connected to the squab comprises a headrest as claimed in claim 14.

26. The vehicle seat as claimed in claim 25, wherein the distance of the headrest relative to the free edge of the back is adjustable, the back comprises a front face configured to come into contact with the back of a user, and the holding element is mounted to pivot about an axis of rotation, substantially transversal to the headrest and placed so that the headrest is configured to be brought into a position in which the holding element covers a portion of the front face of the back.
